(19) United States
(12) Patent Application Publication
(10) Pub. No.: US 2008/0141489 A1
(43) Pub. Date: Jun. 19, 2008

(54) HINGE ASSEMBLY

(75) Inventors: SHENG-CHENG HSU, Tu-Cheng (TW); PU LUO, Shenzhen (CN); JIN-SHU XUE, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/778,081

(22) Filed: Jul. 16, 2007

(30) Foreign Application Priority Data
Dec. 15, 2006 (CN) 200610201307.3

(51) Int. Cl. E05D 11/00

(52) U.S. Cl. 16/223

(57) ABSTRACT

An exemplary hinge assembly (300) for use in a flat display monitor (400) includes a support member (10), a rotatable base (20) and a pivot mechanism (30) for rotatably attaching the rotatable base and the support member together. The rotatable base includes a fixed board (22) and a side board (24) disposed at an end of the fixed board, and the side board forms a stopper (244). The pivot mechanism is rotatably connected to the rotatable base and non-rotatably connected to the support member. The pivot mechanism includes a pivotal shaft. The pivotal shaft defines a limited guide groove (3013) configured for blocking the stopper of the side board so that a range of rotation of the rotatable base relative to the support member is between a first utmost position and a second utmost position.

### BACKGROUND OF THE INVENTION

1. Field of the Invention

The present invention generally relates to hinge assemblies, and particularly, to a hinge assembly typically used for a flat display monitor.

2. Discussion of the Related Art

With the variety of computers available, display devices configured for use with computers also come in a variety of sizes, shapes, and weights. In general, a typical cathode-ray tube (CRT) monitor includes a display panel for displaying an image, a vacuum tube coupled to a rear of the display panel, and an electron gun coupled to the rear of the vacuum tube. This configuration is the predominant factor that determines the total volume and final weight of the CRT monitor. In addition, the CRT monitor has a significant drawback in that a user is easily fatigued when viewing the CRT monitor over several hours due to its low image quality. Due to this problem, many users have switched from a CRT monitor to a flat screen display monitor such as a liquid crystal display (LCD) monitor. Such flat display monitors generally offer the advantages such as reduced weight, less bulky, and high image quality. Furthermore, flat display monitors facilitate easy adjustment of the position of the flat display monitor relative to the user.

The adjustment functions of a flat display monitor are realized with a hinge assembly. A typical hinge assembly includes an L-shaped fixed seat, a pivotal axle, and a number of oiled washers. The fixed seat has a retaining hole. The pivotal axle is pivotally connected with the fixed seat. The pivotal axle has a retaining shoulder formed at a middle portion, a connecting end portion integrally formed at a first end of the retaining shoulder, and a fixed end portion integrally formed at a second end of the retaining shoulder. The connecting end portion of the pivotal axle extends through the retaining hole of the fixed seat with the oiled washers, and is fastened in the fixed seat by a fastening piece. The hinge assembly limits a maximum inclination angle of the flat display monitor by means of the retaining hole in the fixed seat. However, in general, a high degree of precision is required to manufacture the retaining hole, and this tends to increase the cost of manufacturing. In addition, edges of the fixed seat around the retaining hole are prone to being worn out. As a result, the flat display monitor might be rotated beyond the maximum inclination angle, and/or the flat display monitor may not remain stable at the inclination angle selected by a user. Furthermore, during use, in order to be able to rotate the hinge assembly, a user may need to exert a greater than normal effort.

Therefore, a new hinge assembly is desired in order to overcome the above-described shortcomings.

### SUMMARY

In one aspect, a hinge assembly, includes a rotatable base, a support member, and a pivot mechanism for rotatably attaching the rotatable base and the support member together. The rotatable base includes a fixed board and a side board disposed at an end of the fixed board, and the side board forms a stopper. The pivot mechanism is rotatably connected to the rotatable base and non-rotatably connected to the support member. The pivot mechanism includes a pivotal shaft and a fixed piece. The pivotal shaft defines a limited guide groove configured for blocking the stopper of the side board so that a range of rotation of the rotatable base relative to the support member is between a first utmost position and a second utmost position. The fixed piece engages on one end of the pivotal shaft to prevent the pivotal shaft from disengaging from the rotatable base and the support member.

In another aspect, a display monitor includes a display body, a support body; and a hinge assembly. The hinge assembly includes a support member fixed to the support body, a rotatable base fixed to the display body, and a pivot mechanism rotatably interconnecting the rotatable base and the support member. The rotatable base includes a fixed board and a side board disposed at an end of the fixed board, and the side board forms a stopper. The pivot mechanism is rotatably connected to the rotatable base and non-rotatably connected to the support member. The pivot mechanism includes a pivotal shaft and a fixed piece. The pivotal shaft defines a limited guide groove configured for blocking the stopper of the side board so that a range of rotation of the rotatable base relative to the support member is between a first utmost position and a second utmost position. The fixed piece engages on one end of the pivotal shaft to prevent the pivotal shaft from disengaging from the rotatable base and the support member.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present hinge assembly and display monitor. Moreover, in the drawings, like reference numerals designate corresponding parts throughout the several views.

FIG. 1 is an isometric view of a flat display monitor incorporating a hinge assembly (shown in phantom) in accordance with one preferred embodiment of the present invention.

FIG. 2 is an enlarged, exploded, isometric view of the hinge assembly of FIG. 1.

FIG. 3 is an enlarged, assembled, isometric view of the hinge assembly of FIG. 2, showing a rotatable base of the hinge assembly rotated to a first utmost position.

FIG. 4 is similar to FIG. 3, but showing the rotatable base of the hinge assembly rotated to a second utmost position.

FIG. 5 is a cross-sectional view taken along line V-V of FIG. 3.

### DETAILED DESCRIPTION OF THE EMBODIMENTS

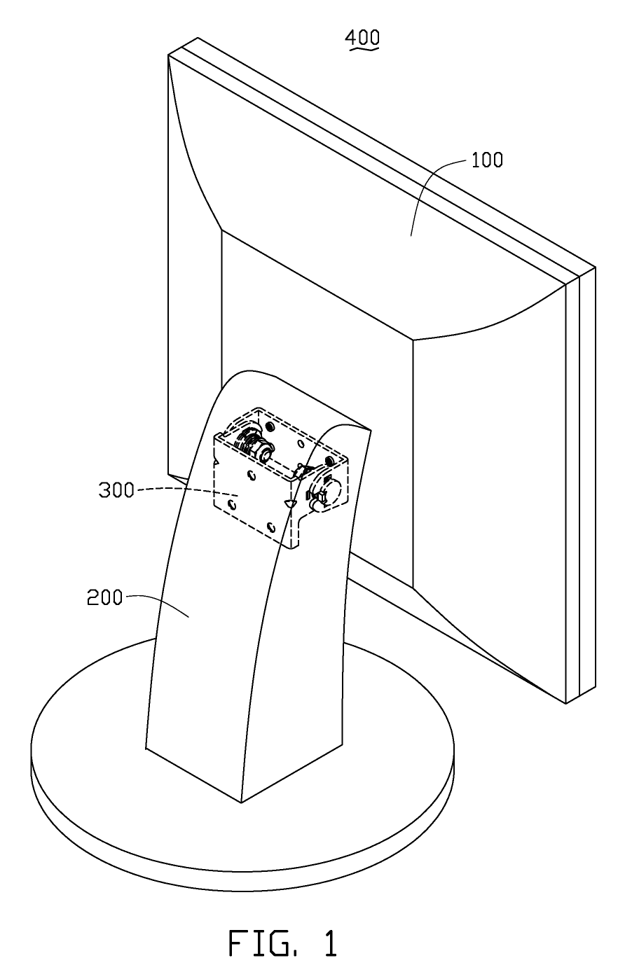

Referring to the drawings in detail, FIG. 1 shows a flat display monitor 400 employing a hinge assembly 300 in accordance with a preferred embodiment of the present invention. The flat display monitor 400 is taken here as an exemplary application for the purpose of describing details of the hinge assembly 300. It is to be understood that the hinge assembly 300 can be advantageously used in numerous other applications, such as cabinet doors, closed-circuit camera installations, etc. Thus, although the hinge assembly 300 provides particular advantages when used in a flat display monitor, the hinge assembly 300 should not be considered to be limited in scope to uses in the field of flat display monitors. The exemplary flat display monitor 400 herein also includes a display body 100 and a support body 200. The hinge assembly 300 connects the display body 100 to the support body 200 such that the display body 100 can be pivoted relative to the support body 200.

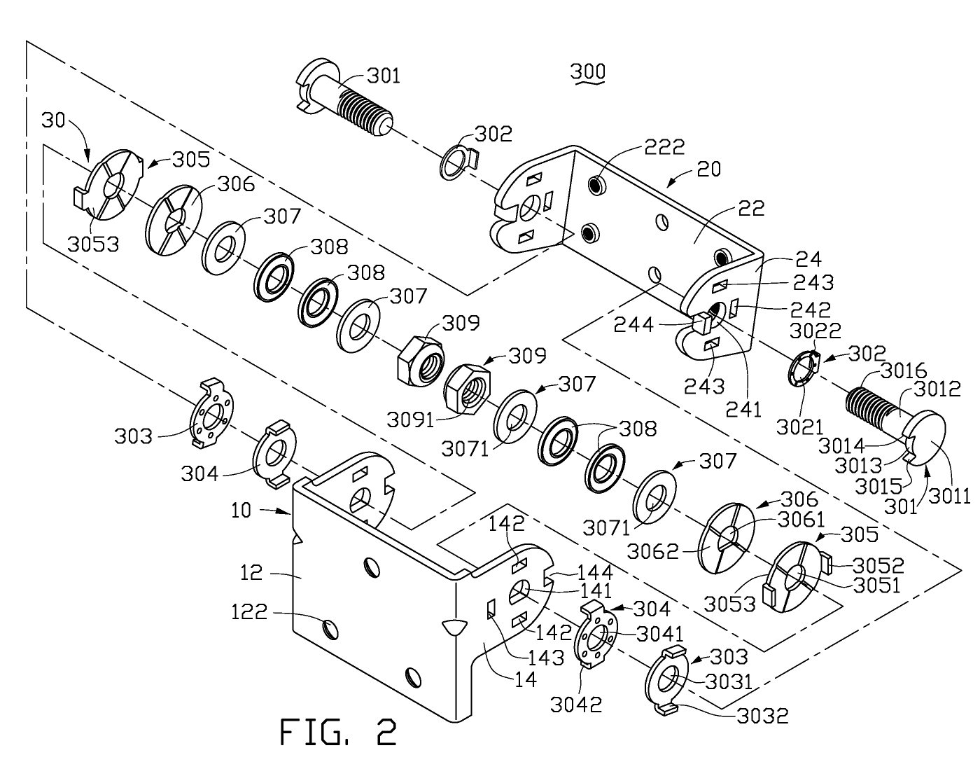

Referring to FIG. 2, the hinge assembly 300 includes a support member 10, a rotatable base 20 and two pivot mechanisms 30. The support member 10 is fixed to the support body 200, and the rotatable base 20 is fixed to the display body 100. The pivot mechanism 30 is used for rotatably attaching the support member 10 and the rotatable base 20 together so that the rotatable base 20 can rotate relative to the support member 10.

The support member 10 includes a mounting portion 12, and two extended seats 14. The mounting portion 12 is substantially a flat plate, and defines a plurality of mounting holes 122. In this embodiment, there are three mounting holes 122. The support member 10 is mounted to the support body 200 by means of the mounting holes 122. The extended seats 14 perpendicularly extend from two opposite sides of mounting portion 12. The extended seats 14 are parallel to each other. Each of the extended seats 14 defines a pivot hole 141 at a centre. The pivot hole 141 of each extended seat 14 has a non-circular shape. The pivot holes 141 of the two extended seats 14 are aligned along a same axis. In the illustrated embodiment, the pivot hole 141 is D-shaped. Each of the extended seats 14 further defines two first fixed holes 142, a second fixed hole 143, and a fixed groove 144 adjacent to the pivot hole 141. The first fixed holes 142, the second fixed hole 143, and the fixed groove 144 are substantially defined around the pivot hole 141 in an alternating manner such that the first fixed holes 142 are on opposite sides of the pivot hole 141 aligned parallel to the mounting portion 12. The second fixed hole 143 and the fixed groove 144 are on opposite sides of the pivot hole 141 aligned perpendicular to the mounting portion 12. Each of the first fixed holes 142, the second fixed hole 143, and the fixed groove 144 is rectangular. The fixed groove 144 is defined on an edge of the extended seat 14. The fixed groove 144 is basically a cutout that communicates between an outer surface and an inner surface of the extended seat 14 and is aligned with the fixed hole 143 perpendicular to the mounting portion 12.

The rotatable base 20 includes a fixed board 22, and two opposite side boards 24. The fixed board 22 defines a plurality of threaded assembling holes 222. In this embodiment, there are four assembling holes 222. The rotatable base 20 is mounted to the display body 100 by means of the assembling holes 222. The side boards 24 perpendicularly extend from two opposite ends of the fixed board 22. Each of the side boards 24 defines a round hole 241 at a centre. Each of the side boards 24 further defines a first latch hole 242 and two second latch holes 243 adjacent to the round hole 241. Each of the first latch holes 242 and the second latch holes 243 is rectangular. As seen in FIG. 2, each of the side boards 24 forms a stopper 244 at a distal end edge of the fixed board 22. The stopper 244 is formed by cutting and bending a portion of the edge, thus defining an opening (not labeled) adjacent to the stopper 244. In this embodiment, the stopper 244 is a rectangular block.

Each pivot mechanism 30 includes a pivot shaft 301, a first tab washer 302, a second tab washer 303, a third tab washer 304, a fourth tab washer 305, a deformed washer 306, two friction washers 307, a pair of resilient rings 308, and a fixed piece 309.

The pivotal shaft 301 is substantially cylindrical, and includes a head 3011, a neck 3012, and a body 3016. As seen in FIG. 2, the head 3011 is substantially disk-like in shape and defines a limited guide groove 3013 on an edge with depth corresponding to the stopper 244 of the rotatable base 20. The limited guide groove 3013 is basically a cutout on a peripheral edge of the head defining a first restricting wall 3014, a second restricting wall 3015, and an arc-shaped guide surface (not labeled). The first restricting wall 3014 and the second restricting wall 3015 are disposed at two opposite sides of the arc-shaped guide surface. A distance between the first restricting wall 3014 and the second restricting wall 3015 is greater than a width of the stopper 244. The body 3016 of the pivotal shaft 301 is threaded, and the body 3016, along with the neck of the shaft is flattened with a cross sectional size and shape corresponding the shape of the pivot hole 141. Thus, threads on the body 3016 are discontinuous. A cross-section of the neck 3012 corresponds to the shape and size of a corresponding one of the pivot hole 141 of the support member 10. That is, the body 3016 and the neck 3012 of the pivotal shaft 301 are passable through the pivot hole 141, and further, retained in the pivot hole 141 of the support member 10 fittingly. In this embodiment, the cross-section of the neck 3012 is D-shaped.

The first tab washer 302 is approximately an annulus shape defining a round hole 3021 in a center portion. A tab 3022 is formed at an edge of the first tab washer 302, and extends along a direction parallel to a central axis of the first tab washer 302. The tab 3022 has a shape and a size corresponding to the first latch hole 242 of the rotatable base 20 so that the first tab washer 302 can be fixed in the rotatable base 20. The first tab washer 302 also defines a plurality of evenly spaced oil holes (not labeled) around the round hole 3021. The oil holes are spherical blind holes configured for receiving lubricating oil. The first tab washer 302 is configured for preventing the flange 3011 of the pivotal shaft 301 from directly touching the corresponding side board 24 of the rotatable base 20. Thereby, abrasions do not occur between the flange 3011 and the side board 24.

The second tab washer 303 is approximately an annulus shape and defines a round hole 3031 at a middle portion thereof. Two tabs 3032 are formed at an edge of the second tab washer 303, and extend along a direction parallel to a central axis the second tab washer 302. Each of the tabs 3032 has a shape and size corresponding to a respective one of the second latch holes 243 of the rotatable base 20 so that the second tab washer 303 can be fixed to the rotatable base 20. The second tab washer 303 also defines a plurality of evenly spaced oil holes (not labeled) around the round hole 3031. The oil holes are spherical blind holes configured for receiving lubricating oil. The second tab washer 303 is configured for preventing the corresponding extended seat 14 of the support member 10 from directly touching the corresponding side board 24 of the rotatable base 20. Thereby, abrasion does not occur between the extended seat 14 and the side board 24.

The third tab washer 304 is approximately an annulus shape and defines a round hole 3041 at a middle portion thereof. Two tabs 3042 are formed at an edge of the third tab washer 304, and extend along a direction parallel to the axis of the third tab washer 304. Each of the tabs 3042 has a shape and size corresponding to a respective one of the first fixed holes 143 of the support member 10 so that the third tab washer 304 can be fixed to the support member 10. The third tab washer 304 also defines a plurality of evenly spaced oil holes (not labeled) around the round hole 3031. The oil holes are spherical blind holes configured for receiving lubricating oil. The third tab washer 304 is configured for preventing the corresponding extended seat 14 of the support member 10 from directly touching the corresponding second tab washer 303. Thereby, abrasion does not occur between the extended seat 14 and the second tab washer 303.

The fourth tab washer 305 is approximately an annulus shape and defines a round hole 3051 at a middle portion thereof. Two tabs 3052 are formed at an edge of the fourth tab washer 305, and extend along a direction parallel to the axis of the fourth tab washer 305. One of the tabs 3052 has a shape and size corresponding to a respective one of the first fixed holes 143 of the support member 10 and the other one of the tabs 3052 has a shape and size corresponding to a respective one of the fixed groove 144 of the support member 10 so that the fourth tab washer 305 can be fixed to the support member 10. The fourth tab washer 305 also forms a deformed wall 3053 thereof. The fourth tab washer 305 is configured for preventing the corresponding extended seat 14 of the support member 10 from directly touching the deformed washer 306. Thereby, abrasion does not occur between the extended seat 14 and the deformed washer 306.

The deformed washer 306 is approximately an annulus shape and defines a deformed hole 3061 at a middle portion thereof. The deformed hole 3061 has a shape and size corresponding to the cross-section of the neck 3012 of the pivotal shaft 301. In this embodiment, the deformed hole 3061 is D-shaped. The deformed washer 306 also forms a deformed wall 3062 corresponding to the deformed wall 3053 of the fourth tab washer 305. The deformed walls 3053, 3062 are configured for providing friction.

The friction washer 307 is approximately an annulus shape, and defines a round hole 3071 at a middle portion.

The resilient rings 308 are generally plate-shaped, and are configured to provide axial force (see below).

The fixed piece 309 may be a screw nut defining a thread 3091 therein, for engaging with the body 3016 of the corresponding pivotal shaft 301.

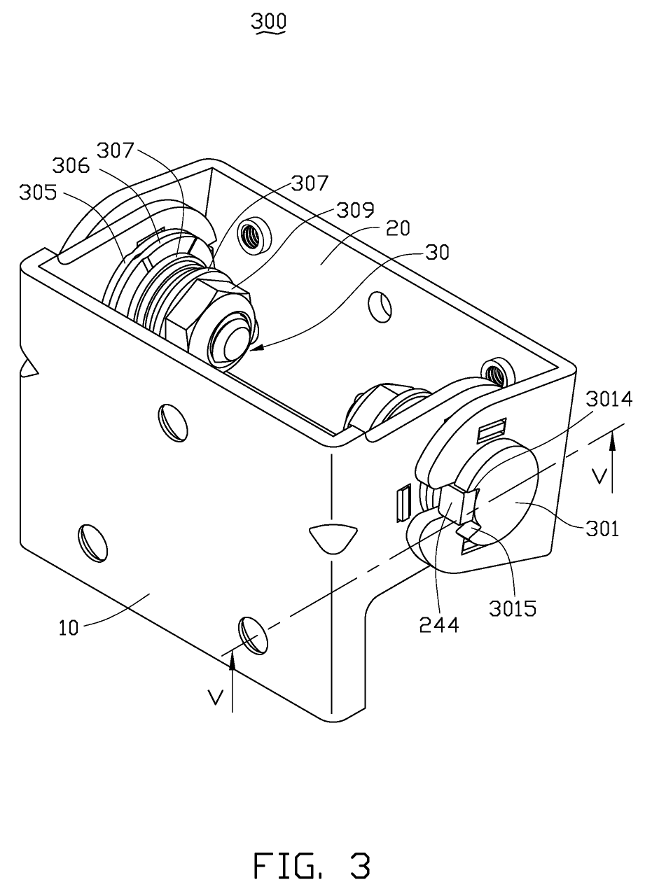

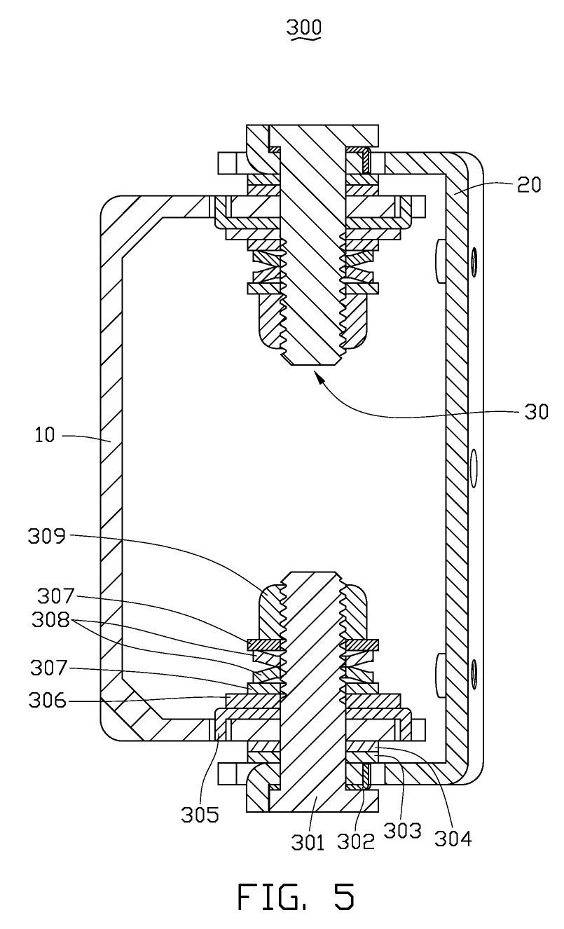

Referring to FIGS. 3 through 5, in assembly of each pivot mechanism 30, the first tab washer 302 is fixed to an exterior side of the rotatable base 20, with the tab 3022 of the first tab washer 302 being received in first latch hole 242 of the rotatable base 20. The second tab washer 303 is fixed to an interior side of the rotatable base 20, with the tabs 3032 of the second tab washer 303 being received in the second latch holes 243. The third tab washer 304 is fixed to an exterior side of the extended seat 14 of the support member 10, with the tabs 3042 of the third tab washer 304 being received in the first fixed holes 142. The fourth tab washer 305 is fixed to an interior side of the extended seat 14 of the support member 10, with one of the tabs 3052 of the fourth tab washer 305 being received in the second fixed holes 143, and the other one of the tabs 3052 of the fourth tab washer 305 being received in the fixed groove 144. The rotatable base 20 is positioned around the support member 10. The round hole 241 of the side boards 24 of the rotatable base 20 are aligned with the pivot holes 141 of the support member 10, with the side boards 24 of the rotatable base 20 disposed at exterior sides of the extended seats 14 of the support member 10. The body 3016 and the neck 3012 of one of the pivotal shafts 301 are passed through the round hole 3021 of one first tab washer 302, the round hole 241 of one side board 24 of the rotatable base 20, the round hole 3031 of one second tab washer 303, the round hole 3041 of one third tab washer 304, the pivot hole 141 of one extended seat 14 of the support member 10, and the round hole 3051 of one fourth tab washer 305, in that order. The pivot hole 141 of one extended seat 14 of the support member 10 engage with the neck 3012 of one pivotal shaft 301, and the stopper 244 of one side of the of the rotatable base 20 is received in the limited guide groove 3013 of one pivotal shaft 301. Therefore, the pivotal shaft 301 cannot rotate relative to the support member 10 and can rotate relative to the rotatable base 20. One deformed washer 306, one friction washer 307, and one pair of the resilient rings 308, and another friction washer 307 are assembled to one pivotal shaft 301, in that order. The pair of resilient rings 308 abut each other, and are oriented symmetrically opposite to each other. The fixed piece 309 is fixed on the pivotal shaft 301 via the body 3016. Thereby, one of the pivot mechanisms 30 is assembled. The other pivot mechanism 30 is assembled in a similar manner.

Then the hinge assembly 300 is used to assemble the flat display monitor 400. The support member 10 is fixed to the support body 200 by means of engagement of fasteners in the mounting holes 122. The fasteners can for example be either bolts or screws. The rotatable base 20 is fixed to the display body 100 by means of engagement of fasteners in the assembling holes 222 of the fixed board 22 of the rotatable base 20. The fasteners can for example be either bolts or screws.

In each pivot mechanism 30 of the hinge assembly 300, the tab washers 302, 303 304, and 305, the deformed washer 306, the friction washers 307, and the pair of resilient rings 308 cooperatively maintain desired spacings between the various components of the pivot mechanism 30. In addition, the tab washers 302, 303 304, and 305, the deformed washer 306, the friction washers 307, and the pair of resilient rings 308 together cooperatively help provide an amount of friction that allows movement of the display body 100 relative to the support body 200 upon application of a moderate force, and that also allows the display body 100 to be stably maintained in a desired position relative to the support body 200. Part of the required an amount of friction can also be obtained through the operation of the other elements of the hinge assembly 300 as well.

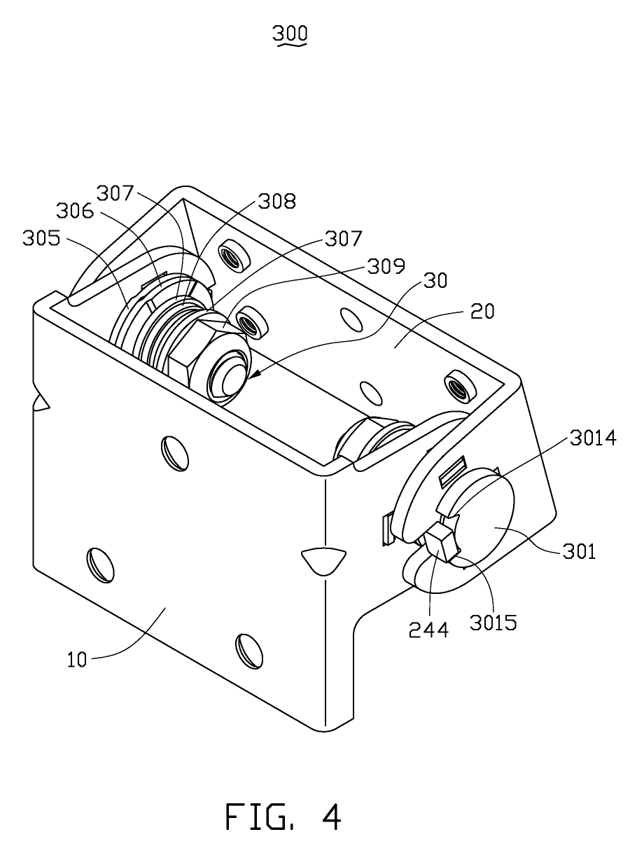

In use, a force is exerted on the display body 100 by a user. Because the support member 10 is fixed relative to the support body 200, the display body 100 in turn causes the rotatable base 20 to move. In each pivot mechanism 30, the first and second tab washers 302, 303 also rotate together with the rotatable base 20, and the stopper 244 of the rotatable base 20 slides along the arc-shaped guide surface of the pivotal shaft 301. Referring to FIG. 3, when the display body 100 rotates through a determined angle in a first direction to a first utmost position, the stopper 244 of the rotatable base 20 resists the first restricting wall 3014 of the pivotal shaft 301. Thereby, the display body 100 together with the rotatable base 20 cannot rotate further in the first direction. Referring to FIG. 4, when the display body 100 rotates through a determined angle in a second direction opposite to the first direction to a second utmost position, the stopper 244 of the rotatable base 20 resists the second restricting wall 3014 of the pivotal shaft 30. Thereby, the display body 100 together with the rotatable base 20 cannot rotate further in the second direction. Thus, the hinge assembly 300 limits a maximum inclination angle of the flat display monitor 400 in each of the first and second directions, by provision of the stopper 244 of the rotatable base 20 and the first and second restricting wall 3014, and 3015 of the pivotal shaft 301.

In alternative embodiments, each of the pivotal shafts 301 can be fastened in position by means of one or more other holding members such as a rivet or a ring. For example, the fixed piece 309 can be replaced by a C-shaped ring, and the body 3016 of the neck 3012 can be accordingly replaced by a receiving groove. Only a single pivot mechanism 30 may be provided. In such case, the above-described configurations of the extended seats 14 of the support member 10, the side boards 24 of the rotatable base 20 need only apply in respect of one of each of these components. Other elastic members such as springs or elastic washers may replace the two resilient rings 308. The support member 10 may be mounted to the display body 100, in which case the rotatable base 20 is mounted to the support body 200.

As described above, the hinge assembly 300 makes it convenient for a user to operate a device such as a flat display screen. In addition, the hinge assembly 300 is durable. It is, however, to be understood that the hinge assembly 300 can be used in other applications in which it may be desirable to allow selective pivot of an object over a limited angular range. For example, the hinge assembly 300 may be applied in a freestanding, adjustable mirror.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A hinge assembly, comprising:
a rotatable base including a fixed board and a side board disposed at an end of the fixed board, the side board defining a round hole at a middle portion thereof and forming a stopper adjacent to the middle portion a support member including an extended seat defining a pivot hole at a middle portion thereof; and
a pivot mechanism for rotatably attaching the rotatable base and the support member together, the pivot mechanism comprising:
a pivotal shaft including a neck running through the round hole, and the pivot hole so as to be rotatably connected to the rotatable base and non-rotatably connected to the support member, and the pivotal shaft defines a limited guide groove configured for blocking the stopper of the side board so that a range of rotation of the rotatable base relative to the support member is between a first utmost position and a second utmost position; and
a fixed piece engaged on one end of the pivotal shaft to prevent the pivotal shaft from disengaging from the rotatable base and the support members.

2. The hinge assembly as claimed in claim 1, wherein the hinge assembly further comprises a pair of resilient rings disposed adjacent to the fixed piece and surrounding the pivotal shaft to provide axial force, and the pair of resilient rings abut each other and are oriented symmetrically opposite to each other.

3. The hinge assembly as claimed in claim 1, wherein the pivotal shaft comprises an head connecting to one end of the neck, is basically a cutout on a peripheral edge of the head defining a first restricting wall, a second restricting wall, and an arc-shaped guide surface, the first restricting wall and the second restricting wall are disposed at two opposite sides of the arc-shaped guide surface, the stopper is formed at a distal end edge of the side board, a distance between the first restricting wall and the second restricting wall is greater than a width of the stopper, and the stopper resists the first restricting wall at the first utmost position, and resists the second restricting wall at the second utmost position.

4. The hinge assembly as claimed in claim 3, wherein the corresponding pivotal shaft further includes a body connecting to an opposite end of the neck, the body of the pivotal shaft is threaded, and, the body, along with the neck of the shaft is flattened with a cross sectional size and shape corresponding the shape of the pivot hole of the support member, and the fixed piece is a screw nut defining a thread therein engaging with the body.

5. The hinge assembly as claimed in claim 4, wherein the cross-section of the neck is D-shaped.

6. The hinge assembly as claimed in claim 4, wherein the support member further comprises a mounting portion and a second extended seat, the two extended seats perpendicularly extend from opposite sides of the mounting portion and the extended seats are parallel to each other.

7. The hinge assembly as claimed in claim 6 wherein the mounting portion of the support member and the fixed board of the rotatable base are substantially a flat plate, and each of the support member and the fixed board defines a plurality of mounting holes therein.

8. The hinge assembly as claimed in claim 4, wherein the hinge assembly further comprises a first tab washer disposed between the head of the pivotal shaft and the side board of the rotatable base, the first tab washer is approximately an annulus shape and defines a round hole at a middle portion for the pivotal shaft running through, a tab is formed at an edge of the first tab washer and extends along a direction parallel to a central axis of the first tab washer, the side board of the rotatable base defines a first latch hole adjacent to the round hole of the side board, and the tab is received in the first latch hole of the rotatable base.

9. The hinge assembly as claimed in claim 8, wherein the hinge assembly further comprises a second tab washer disposed between the support member and the side board of the rotatable base, the second tab is approximately an annulus shape and defines a round hole at a middle portion for the pivotal shaft running through, the two tabs are formed at an edge of the second tab washer, and extend along a direction parallel to a central axis of the second tab washer, the side board of the rotatable base defines two second latch holes adjacent to the round hole of the side board, and the tabs are received in the second latch holes of the rotatable base.

10. The hinge assembly as claimed in claim 9, wherein the first and second tab washer each define a plurality of evenly spaced oil holes around the round hole in the middle portion, the oil holes are spherical blind holes configured for receiving lubricating oil.

11. A display monitor comprising:
a display body;
a support body; and
a hinge assembly including a support member fixed to the support body, a rotatable base fixed to the display body, and a pivot mechanism rotatably interconnecting the rotatable base and the support member, the rotatable base including a fixed board and a side board disposed at an end of the fixed board, the side board defining a round hole at a middle portion thereof and forming a stopper adjacent to the middle portion, the support member including an extended seat defining a pivot hole at a middle portion thereof, and the pivot mechanism including a neck running through the round hole, the pivot hole so as to be rotatably connected to the rotatable base and non-rotatably connected to the support member, and the pivotal shaft defining a limited guide groove configured for blocking the stopper of the side board so that a range of rotation of the rotatable base relative to the support member is between a first utmost position and a second utmost position.

12. The display monitor as claimed in claim 11, wherein the pivotal shaft comprises an head connecting to an end of the neck, is basically a cutout on a peripheral edge of the head defining a first restricting wall, a second restricting wall, and an arc-shaped guide surface, the first restricting wall and the second restricting wall are disposed at two opposite sides of the arc-shaped guide surface, the stopper is formed at a distal end edge of the side board, a distance between the first restricting wall and the second restricting wall is greater than a width of the stopper, and the stopper resists the first restricting wall at the first utmost position, and resists the second restricting wall at the second utmost position.

13. The display monitor as claimed in claim 12, wherein the pivot mechanism further comprises a fixed piece engaged on one end of the pivotal shaft to prevent the pivotal shaft from disengaging from the rotatable base and the support member, the corresponding pivotal shaft further includes a body connecting to an opposite end of the neck, the body of the pivotal shaft is threaded, and, the body, along with the neck of the shaft is flattened with a cross sectional size and shape corresponding the shape of the pivot hole of the support member, and the fixed piece is a screw nut defining a thread therein engaging with the body.

14. The display monitor as claimed in claim 13, wherein the hinge assembly further comprises a pair of resilient rings disposed adjacent to the fixed piece and surrounding the pivotal shaft to provide axial force, and the pair of resilient rings abut each other and are oriented symmetrically opposite to each other.

15. The display monitor as claimed in claim 13, wherein the support member further comprises a mounting portion and a second extended seat, the two extended seats perpendicularly extend from opposite sides of mounting portion and the extended seats are parallel to each other.

16. The display monitor as claimed in claim 15, wherein the mounting portion of the support member and the fixed board of the rotatable base are substantially a flat plate, and each of the support member and the fixed board defines a plurality of mounting holes therein.

17. The display monitor as claimed in claim 13, wherein the hinge assembly further comprises a first tab washer disposed between the head of the pivotal shaft and the side board the rotatable base, the first tab washer is approximately an annulus shape and defines a round hole at a middle portion for the pivotal shaft running through, a tab is formed at an edge of the first tab washer and extends along a direction parallel to a central axis of the first tab washer, the side board of the rotatable base defines a first latch hole adjacent to the round hole of the side board, and the tab is received in the first latch hole of the rotatable base.

18. The display monitor as claimed in claim 17, the hinge assembly further comprises a second tab washer disposed between the support member and the corresponding side board of the rotatable base, the second tab is approximately an annulus shape and defines a round hole at a middle portion for the pivotal shaft running through, the two tabs are formed at an edge of the second tab washer, and extend along a direction parallel to a central axis of the second tab washer, the side board of the rotatable base defines two second latch holes adjacent to the round hole of the side board, and the tabs are received in the second latch holes of the rotatable base.

19. The display monitor as claimed in claim 18, wherein the first and second tab washer each defines a plurality of evenly spaced oil holes around the round hole in the middle portion, the oil holes are spherical blind holes configured for receiving lubricating oil.

20. The display monitor as claimed in claim 18, wherein the hinge assembly further includes a third tab washer fixed to an exterior side of the extended seat of the support member and a fourth tab washer fixed to an interior side of the extended seat of the support member hole, each of the third and fourth tabs is approximately an annulus shape and defines a round hole at a middle portion for the pivotal shaft running through.
